(19) United States
(12) Patent Application Publication
(10) Pub. No.: US 2015/0072233 A1
(43) Pub. Date: Mar. 12, 2015

(54) NEGATIVE ACTIVE MATERIAL AND LITHIUM BATTERY CONTAINING THE NEGATIVE ACTIVE MATERIAL

(71) Applicant: Samsung SDI Co., Ltd., Yongin-si (KR)

(72) Inventors: So-Ra Lee, Yongin-si (KR); Chang-Su Shin, Yongin-si (KR); Ui-Song Do, Yongin-si (KR); Sang-Eun Park, Yongin-si (KR); Xian-Hui Meng, Yongin-si (KR); Jae-Myung Kim, Yongin-si (KR)

(21) Appl. No.: 14/338,160

(22) Filed: Jul. 22, 2014

(30) Foreign Application Priority Data
Sep. 10, 2013 (KR) 10-2013-0108619

(51) Int. Cl. H01M 4/36; H01M 4/62; H01M 4/66; H01M 4/38

(52) U.S. Cl. CPC H01M 4/366; H01M 4/386; H01M 4/622; H01M 4/661; H01M 10/0525
USPC 429/217; 429/221

(57) ABSTRACT

A negative active material and a lithium battery including the same are disclosed. The negative active material includes a primary particle including a silicon nanowire formed on a non-carbonaceous conductive core to increase the capacity and cycle lifespan properties of the lithium battery.

### CROSS-REFERENCE TO RELATED APPLICATIONS

Any and all priority claims identified in the Application Data Sheet, or any correction thereto, are hereby incorporated by reference under 37 CFR 1.57. For example, this application claims the benefit of Korean Patent Application No. 10-2013-0108619, filed on Sep. 10, 2013 in the Korean Intellectual Property Office, the disclosures of which are incorporated herein by reference in their entirety.

### BACKGROUND

1. Field

The disclosed technology relates to a negative active material and a lithium battery including the negative active material.

2. Description of the Related Technology

Lithium secondary batteries are widely used in portable electronic devices such as PDAs, mobile phones, or notebook computers, electric bicycles, electric vehicles, or the like. The lithium secondary battery has high energy density and a discharge voltage that is at least twice higher than that of a conventional battery.

Lithium secondary batteries generate electric energy by oxidation and reduction reactions occurring when lithium ions are intercalated into and deintercalated from a positive electrode and a negative electrode. Each of the electrodes includes an active material that enables intercalation and deintercalation of lithium ions, with an organic electrolytic solution or a polymer electrolytic solution interposed between the positive and negative electrodes.

Research has been conducted on non-carbonaceous materials and various forms of carbonaceous materials including synthetic and natural graphite, and hard carbon, which are capable of intercalation/deintercalation of lithium, and Si.

Among the non-carbonaceous materials, graphite is generally used as a substrate for growing silicon-based nanowires (SiNW). However, when the silicon-based nanowires grown on the graphite substrate are used as a negative active material, rapid electrolyte depletion occurs continuously. This may be due to simultaneous exposure of the highly conductive graphite nearby and the silicon-based nanowire, which has relatively lower conductivity.

When the negative electrode is charged, the electrolyte preferentially dissolves in a highly conductive location to form a solid electrolyte interface (SET). The silicon-based nanowire has low conductivity and forms the SEI very slowly, thereby forming an SEI at a location in which the reduction potential due to lithium (Li) charging is 0.8 V or less. This is a voltage at which the salt dissolves. Accordingly, unstable salt degradation products accumulate on the surface of the silicon-based nanowire. Because of this unstable negative electrode surface, a continuous dissolution of the electrolyte solution occurs, thereby causing cell failure by the depletion of the electrolyte solution.

Accordingly, development of a high performance negative active material that may improve cycle lifespan characteristics of a lithium battery is needed.

### SUMMARY OF CERTAIN INVENTIVE ASPECTS

One aspect of the disclosure relates to a negative active material that may increase lifespan characteristics of a lithium secondary battery.

Another aspect of the disclosure relates to a lithium secondary battery including the negative active material.

In some embodiments, a negative active material can include a primary particle, the primary particle including a non-carbonaceous conductive core; and a silicon-based nanowire disposed on the non-carbonaceous conductive core.

In some embodiments, the non-carbonaceous conductive core may include at least one selected from copper (Cu), nickel (Ni), cobalt (Co), iron (Fe), manganese (Mn), molybdenum (Mo), titanium (Ti), silicon (Si), and an alloy thereof.

In some embodiments, the non-carbonaceous conductive core may have a spherical powder form.

In some embodiments, an average diameter of the non-carbonaceous conductive core may be about 1 μm to about 30 μm.

In some embodiments, the silicon-based nanowire may include at least one selected from Si, SiOx (0<x<2), Si—Z alloys (where Z is alkali metal, alkaline earth metal, a Group 11 element, a Group 12 element, a Group 13 element, a Group 14 element, a Group 15 element, a Group 16 element, a transition metal, a rare earth element, or a combination thereof, and is not Si), or a combination thereof. According to one or more embodiments, the silicon-based nanowire may be a Si nanowire.

In some embodiments, the silicon-based nanowire may have a diameter of about 10 nm to about 500 nm, and a length of about 0.1 μm to about 100 μm.

In some embodiments, the silicon-based nanowire may be directly grown on the non-carbonaceous conductive core, and another embodiment may include wherein the silicon-based nanowire may be grown in the presence of at least one metal catalyst of platinum (Pt), iron (Fe), nickel (Ni), cobalt (Co), gold (Au), silver (Ag), copper (Cu), zinc (Zn), and cadmium (Cd).

In some embodiments, the amount of the non-carbonaceous conductive core may be about 60 wt % to about 99 wt % and an amount of the silicon-based nanowire may be about 1 wt % to about 40 wt %, based on an amount of the primary particle.

In some embodiments, the primary particle may further include an amorphous carbonaceous coating layer, which may be coated on at least a portion of the primary particle, such that at least a portion of the silicon-based nanowire is not exposed.

In some embodiments, at least about 50 volume % of the silicon-based nanowire may be buried in the amorphous carbonaceous coating layer.

In some embodiments, the thickness of the amorphous carbonaceous coating layer may be about 0.1 μm to about 10 μm.

In some embodiments, the amorphous carbonaceous coating layer may include amorphous carbon selected from soft carbon, hard carbon, mesophase pitch carbide, calcined coke, and a combination thereof.

In some embodiments, an amount of the amorphous carbonaceous coating layer may be about 0.1 wt % to about 30 wt %, based on an amount of the primary particle.

In some embodiments, the negative active material may further include at least one carbon-based particle of natural graphite, synthetic graphite, expandable graphite, graphene, carbon black, fullerene soot, carbon nanotubes, carbon fibers, and a combination thereof.

In some embodiments, the carbon-based particle may have a spherical form, a flat form, a fiber form, a tube form, or a powder form.

In some embodiments, provided is a lithium battery including a negative electrode comprising the negative active material described above; a positive electrode comprising a positive active material, which is disposed opposite to the negative electrode; and an electrolyte disposed between the negative electrode and the positive electrode.

In some embodiments, the negative electrode may further include at least one binder of polyvinylidene fluoride, polyvinylidene chloride, polybenzimidazole, polyimide, polyvinyl acetate, polyacrylonitrile, polyvinyl alcohol, carboxymethylcellulose (CMC), starch, hydroxypropyl cellulose, regenerated cellulose, polyvinylpyrrolidone, polyethylene, polypropylene, polystyrene, polymethylmethacrylate, polyaniline, acrylonitrile butadiene styrene, a phenol resin, an epoxy resin, polyethylene terephthalate, polytetrafluoroethylene, polyphenylene sulfide, polyamideimide, polyetherimide, polyethylenesulfone, polyamide, polyacetal, polyphenylene oxide, polybutylene terephthalate, ethylene-propylene-diene terpolymer (EPDM), sulfonated ethylene-propylene-diene terpolymer, styrene butadiene rubber, fluoride rubber, and a combination thereof. An amount of the binder may be about 1 part by weight to about 50 parts by weight. In greater detail, the amount of the binder may be about 1 part by weight to about 30 parts by weight, 1 part by weight to about 20 parts by weight, or about 1 part by weight to about 15 parts by weight.

In some embodiments, the negative electrode may include at least one conductive agent of carbon black, acetylene black, Ketjen black, carbon fiber, copper, nickel, aluminum, silver, conductive polymer, and a combination thereof.

Additional aspects will be set forth in part in the description which follows and, in part, will be apparent from the description, or may be learned by practice of the presented embodiments.

### BRIEF DESCRIPTION OF THE DRAWINGS

FIG. 1 is a schematic view of a lithium battery.

FIG. 2 shows measurement results of capacity retention rates (CRR) of the lithium batteries manufactured in Example 1 and Comparative Example 1.

### DETAILED DESCRIPTION OF CERTAIN INVENTIVE EMBODIMENTS

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

Hereinafter, one or more embodiments are described in detail.

In some embodiments, the negative active material includes a primary particle including a non-carbonaceous conductive core; and silicon-based nanowires disposed on the non-carbonaceous conductive core.

Herein, the term “non-carbonaceous” means not substantially including carbon. For example, the term “non-carbonaceous” means including about 5 wt % or less, about 4 wt % or less, about 3 wt % or less, about 2 wt % or less, or about 1 wt % or less carbon, or not including carbon at all.

In some embodiments, the non-carbonaceous conductive core not only acts as a support for immobilizing the silicon-based nanowires disposed thereon, but also as a collector that collects electrons by electrical conductivity of the non-carbonaceous conductive core, just like a current collector of an electrode plate. Accordingly, reduced electrical conductivity due to the silicon-based nanowires may be supplemented.

Also, the negative active material in which the silicon-based nanowires are grown on the non-carbonaceous conductive core may not have any other material that has higher electrical conductivity than silicon in another energy level in which lithium may react. Thus, a solid electrolyte interface (SET) may form stably on the surfaces of the silicon-based nanowires. On the contrary, when silicon-based nanowires are grown on a graphite substrate, an SEI forms on the surface of the graphite substrate first, causing lithiation of the silicon-based nanowires to lower the surface energy level of the silicon-based nanowires, and causing dissolution of an electrolyte salt on the surfaces of the silicon-based nanowires. Accordingly, the negative active material in which the silicon-based nanowires are grown on the non-carbonaceous conductive core may prevent rapid electrolyte solution dissolution phenomenon caused by the co-existence of silicon-based nanowires and graphite, thereby increasing the lifespan of a lithium battery.

In some embodiments, the non-carbonaceous conductive core may include at least one of copper (Cu), nickel (Ni), cobalt (Co), iron (Fe), manganese (Mn), molybdenum (Mo), titanium (Ti), silicon (Si), and an alloy thereof. In some embodiments, the non-carbonaceous conductive core may include at least one of Cu, Ni, and Co. In some embodiments, the non-carbonaceous conductive core may include stainless steel, which includes Fe, chromium (Cr), and the like as basic materials.

The non-carbonaceous conductive core may have a spherical powder form. Herein, the term “spherical” means that at least a portion of the non-carbonaceous conductive core may have a gently or sharply curved external shape. The carbonaceous material may have a complete spherical shape, or have an incomplete spherical shape or an oval shape. It may further have an uneven surface.

An average diameter of the non-carbonaceous conductive core is not particularly limited, and may be for example, about 1 μm to about 30 μm. In some embodiments, the non-carbonaceous conductive core may have an average diameter of about 1 μm to about 25 μm, or in more detail, about 1 μm to about 20 μm. When the average diameter of the non-carbonaceous conductive core is too small, a wide specific surface area may negatively affect stability of slurry, and when the average diameter is too big, the surface area on which the silicon-based nanowires may be located may be too small, thereby causing difficulties in loading a sufficient amount of the silicon-based nanowires. Thus, when the average diameter is within the range described above, a stable electrode plate with sufficient capacity may be obtained.

In some embodiments, the silicon-based nanowires are disposed on the non-carbonaceous conductive core. Herein, the term “silicon-based” refers to inclusion of at least about 50 wt % of Si, for example, at least about 60 wt %, about 70 wt %, about 80 wt %, or about 90 wt % of Si, or may include 100 wt % of Si alone. Also, in this regard, the term “nanowire” used herein refers to a wire structure having a nano-diameter cross-section. For example, the nanowire may have a cross-sectional diameter of about 10 nm to about 500 nm and a length of about 0.1 μm to about 100 μm. Also, an aspect ratio (length:width) of each nanowire may be about 10 or more, for example, about 50 or more, or for example, about 100 or more. Also, diameters of nanowires may be substantially identical to or different from each other, and from among longer axes of nanowires, at least a portion may be linear, gently or sharply curved, or branched. Such silicon-based nanowires may withstand a volumetric change of a lithium battery due to charging and discharging.

In some embodiments, the silicon-based nanowires may include a material selected from the group consisting of Si, SiOx (0<x<2), Si—Z alloys (where Z is alkali metal, alkaline earth metal, a Group 13 element, a Group 14 element, a Group 15 element, a Group 16 element, a transition metal, a rare earth element, or a combination thereof, and is not Si), or a combination thereof, but a material for forming the silicon-based nanowires is not limited thereto. The element Z may be selected from the group consisting of Mg, Ca, Sr, Ba, Ra, Sc, Y, La, Ti, Zr, Hf, V, Nb, Ta, Cr, Mo, W, Tc, Re, Fe, Ru, Os, Co, Rh, Jr, Ni, Pd, Pt, Cu, Ag, Au, Zn, Cd, B, Ge, P, As, Sb, Bi, S, Se, Te, Po, and a combination thereof. Also, the silicon-based materials such as silicon(Si), SiOₓ, and Si—Z alloy may include amorphous silicon, crystalline (including single or poly crystalline) silicon, or a combination thereof. The silicon-based nanowires may include these materials alone or in a combination. For example, the silicon-based nanowires may be used as the silicon-based nanowires in consideration of high capacity.

The silicon-based nanowires may be manufactured by directly growing silicon-based nanowires on the non-carbonaceous conductive core, or by disposing, for example, attaching or coupling silicon-based nanowires, which have been grown separately from the non-carbonaceous conductive core.

In some embodiments, the silicon-based nanowires may be disposed on the non-carbonaceous conductive core by using any known methods. For example, a nanowire may be grown by using vapor to liquid deposition (VLD), vapor-liquid-solid (VLS) growth method, or using a nano-sized catalyst that thermally decomposes a precursor gas nearby. The VLS method involves changing a lump or a thin film form raw material into a gas form to disperse the raw material, changing the dispersed raw material into a liquid state, and precipitating the liquid raw material to grow solid silicon-based nanowires. Also, the silicon-based nanowires may be prepared by using a nano-sized catalyst that thermally decomposes the precursor gas near the catalyst. The silicon-based nanowires may be directly grown on the non-carbonaceous core in the presence or absence of a metal catalyst. Examples of the metal catalyst include but are not limited to Pt, Fe, Ni, Co, Au, Ag, Cu, Zn, Cd, etc.

In some embodiments, the primary particle may include the non-carbonaceous conductive core in such an amount that the high-capacity silicon-based nanowires are sufficiently included and the silicon-based nanowires are immobilized. For example, the amount of the non-carbonaceous core may be in a range of about 50 to about 99 wt %, and the amount of the silicon-based nanowires may be in a range of about 1 to about 50 wt %.

In some embodiments, the primary particle may further include an amorphous carbonaceous coating layer, which is coated on at least a portion of the primary particle, such that at least a portion of the silicon-based nanowires may not be exposed. Also, the term “carbonaceous” refers to inclusion of at least about 50 wt % of carbon. For example, inclusion of at least about 60 wt %, about 70 wt %, about 80 wt %, or about 90 wt % of carbon, or about 100 wt % of carbon alone. Also, the term “amorphous” refers to inclusion of at least about 50 wt %, about 60 wt %, about 70 wt %, about 80 wt %, or about 90 wt % amorphous carbon, or 100 wt % of amorphous carbon alone.

In some embodiments, the amorphous carbonaceous coating layer may be formed such that at least about 50 volume % of the silicon-based nanowires are buried in the amorphous carbonaceous coating layer. For example, at least about 60 volume %, about 70 volume %, about 80 volume %, or about 90 volume % of the silicon-based nanowires may be buried in the amorphous carbonaceous coating layer. In some embodiments, the amorphous carbonaceous coating layer may be coated on the primary particle such that the silicon-based nanowires are completely buried in the surface of the primary particle.

The coated amorphous carbonaceous coating layer prevents deintercalation of the silicon-based nanowires during charging and discharging of the battery and may contribute to the stability of an electrode and increase the lifespan of a lithium battery.

In some embodiments, the amorphous carbonaceous coating layer may include a material selected from soft carbon (i.e. low temperature calcined carbon), hard carbon, pitch carbide, mesophase pitch carbide, calcined coke, and a combination thereof.

Non-limiting examples of a method of coating the amorphous carbonaceous coating layer include dry coating or liquid coating. Examples of the dry coating include deposition and chemical vapor deposition (CVD), and examples of the liquid coating include impregnation and spraying. For example, the primary particle in which the silicon-based nanowires are disposed on the non-carbonaceous core may be coated with carbon precursors such as coal tar pitch, mesophase pitch, petroleum pitch, coal tar oil, petroleum heavy oil, organic synthetic pitch, or a polymer resin such as a phenol resin, a furan resin, or a polyimide resin, and the materials are then heat treated to form an amorphous carbonaceous coating layer.

The amorphous carbonaceous coating layer may be formed to have a thickness in a range such that a sufficient conductive pathway is provided without decreasing a capacity of the battery. For example, the amorphous carbonaceous coating layer may be formed in a thickness of about for example, from about 0.1 μm to about 10 μm, in greater detail, from about 0.5 μm to about 10 μm, and in more detail, from about 1 μm to about 5 μm, but the thickness is not limited thereto.

In some embodiments, the amount of the amorphous carbonaceous coating layer may be about 0.1 wt % to about 30 wt % based on the amount of the primary particle. For example, the amount of the amorphous carbonaceous coating layer may be about 1 wt % to about 25 wt %, more particularly about 5 wt % to about 25 wt %, based on an amount of the primary particle. In the range described above, an amorphous carbonaceous coating layer having a suitable thickness may be formed, and conductivity may be provided to the negative active material.

In some embodiments, the primary particle may aggregate or bind together, or it may form a secondary particle by combining with other active material components.

In some embodiments, the negative active material may further include a carbonaceous particle including at least one of natural graphite, synthetic graphite, expandable graphite, graphene, carbon black, fullerene soot, carbon nanotubes, carbon fibers and a combination thereof, along with the primary particle. Here, the carbonaceous particle may have a spherical form, a flat form, a fiber form, a tube form, or a powder form. For example, the carbonaceous particle may be added to the negative active material in the original form of each material, in other words, a spherical form, a flat form, a fiber form, a tube form, or a powder form, or the carbonaceous material may be spheroidized into a spherical particle and then added to the negative active material.

In some embodiments, a lithium battery includes a negative electrode including the negative active material; a positive electrode including a positive active material, which is disposed opposite to the negative electrode; and an electrolyte disposed between the negative and positive electrodes.

The negative electrode may include the negative active material. The negative electrode may be manufactured by using various methods. For example, the negative active material, a binder, and selectively, a conductive agent are mixed in a solvent to prepare a negative active material composition, and then the negative active material composition is molded into a predetermined shape. Alternatively, the negative active material composition may be coated on a current collector, such as a copper foil or the like.

In some embodiments, the binder included in the negative active material composition may assist the bonding between the negative active material and, for example, a conductive agent and a bond between the negative active material and a current collector. The amount of the binder herein may be in the range of about 1 to about 50 parts by weight based on 100 parts by weight of the negative active material. For example, the amount of the binder may be in the range of about 1 to about 30 parts by weight, about 1 to about 20 parts by weight, or about 1 to about 15 parts by weight, based on 100 parts by weight of the negative active material. Examples of the binder include but are not limited to polyvinylidene fluoride, polyvinylidene chloride, polybenzimidazole, polyimide, polyvinyl acetate, polyacrylonitrile, polyvinyl alcohol, carboxymethylcellulose (CMC), starch, hydroxypropyl cellulose, regenerated cellulose, polyvinylpyrrolidone, polyethylene, polypropylene, polystyrene, polymethylmethacrylate, polyaniline, acrylonitrile butadiene styrene, phenol resin, epoxy resin, polyethylene terephthalate, polytetrafluoroethylene, polyphenylene sulfide, polyamideimide, polyetherimide, polyethylenesulfone, polyamide, polyacetal, polyphenylene oxide, polybutylene terephthalate, ethylene-propylene-diene terpolymer (EPDM), sulfonated EPDM, styrene butadiene rubber, fluoride rubber, various copolymers, and a combination thereof.

In some embodiments, the negative electrode may optionally further include a conductive agent to provide a conductive pathway to the negative active material to further improve electrical conductivity. As the conductive agent, any material used in a typical lithium battery may be used. Examples of the conductive agent are a carbonaceous material such as carbon black, acetylene black, Ketjen black, carbon fiber (for example, a vapor phase growth carbon fiber), or the like; a metal such as copper, nickel, aluminum, silver, or the like, each of which may be used in powder or fiber form; a conductive polymer such as a polyphenylene derivative; and a mixture thereof. An amount of the conductive agent may be appropriately controlled. For example, the conductive agent may be added in such an amount that a weight ratio of the negative active material to the conductive agent is in a range of about 99:1 to about 90:10.

In some embodiments, the solvent may be N-methylpyrrolidone (NMP), acetone, water, or the like. The amount of the solvent may be in a range suitable for forming the active material layer.

In some embodiments, the current collector may typically be formed in the thickness of about 3 μm to about 500 μm. The current collector is not particularly limited as long as the current collector does not cause a chemical change in a battery and has conductivity. Examples of a material that forms the current collector are copper, stainless steel, aluminum, nickel, titanium, calcined carbon, copper and stainless steel that are surface-treated with carbon, nickel, titanium, silver, or the like, an alloy of aluminum and cadmium, etc. Also, an uneven micro structure may be formed on the surface of the current collector to enhance a binding force with the negative active material. Also, the current collector may be used in various forms including a film, a sheet, a foil, a net, a porous structure, a foaming structure, a non-woven structure, etc.

The prepared negative active material composition may be directly coated on a current collector to form a negative electrode plate, or may be cast onto a separate support and a negative active material film separated from the support is laminated on a current collector, such as a copper foil, to obtain a negative electrode plate. The negative electrode is not limited to the forms listed above, and may have a form other than those listed.

The negative active material composition may be printed on a flexible electrode substrate to manufacture a printable battery, in addition to the use in manufacturing a lithium battery.

Separately, for manufacturing a positive electrode, the positive active material composition prepared by mixing a positive active material, a conductive agent, a binder, and a solvent is prepared.

Any lithium-containing metal oxide that is used in the art may be used as a positive active material. For example, LiCoO₂, LiMnₓO₂ₓ (where x is 1 or 2), LiNi₁₋ₓMnₓO₂ (where 0<x<1), or LiNi_{1-x-y}CoₓMn_{y}O₂ (where 0≦x≦0.5 and 0≦y≦0.5), or the like may be used. For example, a compound that intercalates and/or deintercalates lithium, such as LiMn₂O₄, LiCoO₂, LiNiO₂, LiFeO₂, V₂O₅, TiS, MoS, or the like, may be used as the positive active material.

The conductive agent, the binder, and the solvent used in preparing the positive active material composition may be identical to those included in the negative active material composition. In some cases, a plasticizer may be further added to each of the positive active material composition and the negative active material composition to form pores in a corresponding electrode plate. The amount of the positive active material, the conductive agent, the binder, and the solvent may be the same as used in a conventional lithium battery.

In some embodiments, the positive electrode current collector may have a thickness of about 3 μm to about 500 μm, and may be any of various current collectors that do not cause a chemical change in a battery and have high conductivity. Examples of the positive electrode current collector are stainless steel, aluminum, nickel, titanium, calcined carbon, and aluminum and stainless steel that are surface-treated with carbon, nickel, titanium, silver, or the like. The positive electrode current collector may have an uneven micro structure on its surface to enhance a binding strength with the positive active material. Also, the current collector may be used in various forms including a film, a sheet, a foil, a net, a porous structure, a foam structure, a non-woven structure, etc.

The prepared positive active material composition may be directly coated on the positive electrode current collector to form a positive electrode plate, or may be cast onto a separate support and a positive active material film separated from the support may be laminated on the positive electrode current collector to obtain a positive electrode plate.

The positive electrode may be separated from the negative electrode by a separator. The separator may be any of various separators typically used in a lithium battery. For example, the separator may include a material that has a low resistance to migration of ions of an electrolyte and an excellent electrolytic solution-retaining capability. For example, the separator may include a material selected from the group consisting of glass fiber, polyester, Teflon, polyethylene, polypropylene, polytetrafluoroethylene (PTFE), and a combination thereof, each of which may be nonwoven or woven. The separator may have a pore size in the range of about 0.01 μm to about 10 μm and a thickness of about 5 μm to about 300 μm.

In some embodiments, the lithium salt-containing non-aqueous based electrolyte includes a non-aqueous electrolyte and lithium salt. Examples of the non-aqueous electrolyte are a non-aqueous electrolytic solution, an organic solid electrolyte, an inorganic solid electrolyte, etc.

An aprotic organic solvent may be used as the non-aqueous electrolytic solution. Examples of the aprotic organic solvent are N-methyl-2-pyrrolidone, propylene carbonate, ethylene carbonate, butylene carbonate, dimethyl carbonate, diethyl carbonate, gamma-butyrolactone, 1,2-dimethoxy ethane, tetrahydrofuran, 2-methyltetrahydrofuran, dimethylsulfoxide, 1,3-dioxolane, 4-methyldioxolane, formamide, N,N-dimethylformamide, acetonitrile, nitromethane, methyl formic acid, methyl acetic acid, phosphate triester, trimethoxymethane, dioxolane derivatives, sulfolane, methyl sulfolane, 1,3-dimethyl-2-imidazolidinone, propylene carbonate derivatives, tetrahydrofuran derivatives, ethers, methyl propionic acid, ethyl propionic acid, etc.

Examples of the organic solid electrolyte include but are not limited to polyethylene derivatives, polyethylene oxide derivatives, polypropylene oxide derivatives, phosphate ester polymers, polyester sulfide, polyvinyl alcohol, vinylidene polyfluoride, a polymer having an ionic dissociable group, etc.

Examples of the inorganic solid electrolyte include but are not limited to nitrides, halides, sulfates, and silicates of Li, such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄—Li₂S—SiS₂, or the like.

The lithium salt may be any one of the various lithium salts used in a lithium battery. As a material that may be dissolved well in the non-aqueous electrolyte, for example, one or more of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lower aliphatic carbonic acid lithium, 4 phenyl boric acid lithium, lithium imide, etc may be used.

Lithium batteries may be categorized as lithium ion batteries, lithium ion polymer batteries, or lithium polymer batteries, according to a separator used and an electrolyte used. Lithium batteries may also be categorized as cylindrical lithium batteries, rectangular lithium batteries, coin-shaped lithium batteries, or pouch-shaped lithium batteries, according to the shape thereof. Lithium batteries may also be categorized as bulk-type lithium batteries or thin layer-type lithium batteries, according to the size thereof. The lithium batteries may also be primary batteries or secondary batteries.

A method of manufacturing lithium batteries is well known to one skilled in the art, and thus, will not be described in detail herein.

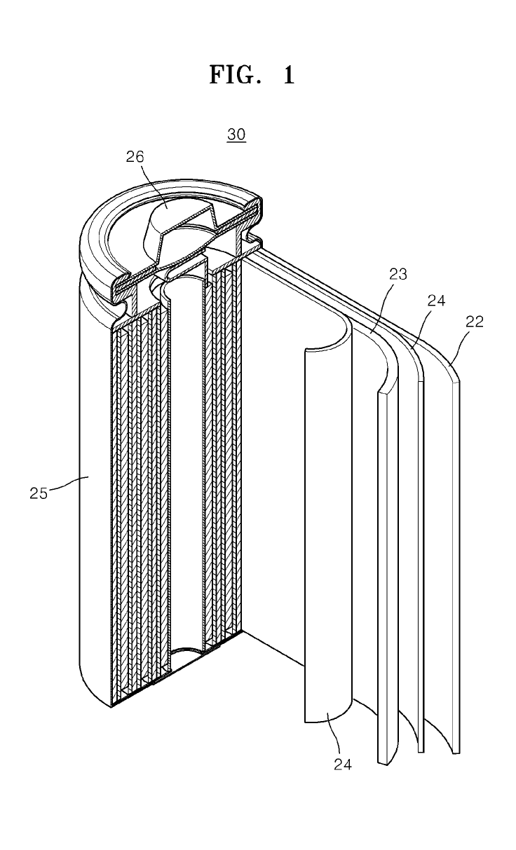

FIG. 1 is a schematic view of a lithium battery 30.

Referring to FIG. 1, the lithium battery 30 includes a positive electrode 23, a negative electrode 22, and a separator 24 interposed between the positive and negative electrodes 22 and 23. The positive electrode 23, the negative electrode 22, and the separator 24 are wound or folded to be housed in a battery case 25. Then, an electrolyte is injected into the battery case 25, followed by sealing the battery case 25 with an encapsulation member 26, thereby completing the manufacture of the lithium battery 30. The battery case 25 may be a cylindrical, rectangular, or thin film type case. The lithium battery 30 may be a lithium ion battery.

The lithium battery may be used in an application, such as an electric vehicle that requires high capacity, high power output, and high-temperature driving, in addition to existing applications in mobile phones or portable computers. Also, the lithium battery may be combined with an existing internal-combustion engine, a fuel cell, a super capacitor, or the like for use in a hybrid vehicle, or the like. Furthermore, the lithium battery may be used in any other applications that require high power output, high voltage, and high-temperature driving.

Hereinafter, exemplary embodiments will be described in detail with reference to examples. However, the examples are illustrated for illustrative purpose only and do not limit the scope.

### Example 1

Silicon (Si) nanowires (SiNWs) were grown on the stainless steel powder (available from Goodfellow, London, UK, Stainless Steel—AISI 316L Powder: average diameter of about 3 μm) by using VLD growth. To grow the SiNWs, VLS growth was used, an Ag catalyst was formed on a surface of SUS powder, and then SiH₄ gas was provided thereto at a temperature of 500° C. or greater. The SiNWs had an average diameter of about 30 nm to about 50 nm, an average length of about 1.5 μm, and an amount of the SiNWs was about 7.15 wt %.

The negative active material, a styrene butadiene rubber (SBR), and carboxy methylcellulose (CMC) were mixed in a weight ratio of 97:1.5:1.5 and N-methyl pyrrolidone was added thereto such that solid content was about 50 wt %, to prepare negative electrode slurry. The negative electrode slurry was coated on a copper foil current collector having a thickness of 10 μm to prepare a negative electrode plate. The completely coated negative electrode plate was dried at a temperature of 120° C. for 15 minutes and then the negative electrode plate was pressed to prepare a negative electrode having a thickness of 60 μm.

LiCoO₂ powder as a positive active material, polyvinylidene fluoride (PVDF) as a binder, and carbon conductor as a conductor (Super-P; available from Timcal Ltd., Bodio, Switzerland) were mixed in a weight ratio of 97:1.5:1.5 and the solvent N-methylpyrrolidone was added thereto such that solid content was 60 wt %, to prepare positive electrode slurry. The positive electrode slurry was coated on an aluminum foil having a thickness of 15 μm and then pressed to prepare a positive electrode.

A separator (product name: STAR20, available from Asahi, Japan) having a thickness of 20 μm formed of polyethylene material was disposed between the positive and negative electrodes, and an electrolyte solution was injected thereto to manufacture a lithium battery. To this end, the electrolyte solution was a solution in which LiPF₆ was dissolved to a concentration of 1.10 M in a mixture solution of ethylene carbonate (EC), ethyl methyl carbonate (EMC), and diethyl carbonate (DEC) (a volume ratio of 3:3:4 of EC:EMC:DEC).

### Comparative Example 1

The negative active material was prepared and then the lithium battery was manufactured according to the same procedures described in Example 1, except that SiNWs were grown by using synthetic graphite (average diameter of 15 μm) available from Hitachi Chemical Co (Japan) as a graphite substrate.

Here, VLS growth was used to grow the SiNWs, an Ag catalyst was formed on surface of synthetic graphite, and SiH₄ gas was provided thereto at a temperature of 500° C. to grow the SiNWs.

### Comparative Example 2

In Comparative Example 1, pitch coating was performed by using coal tar pitch in an amount of 20 wt % based on 100 wt % of the entire active material, a surface of which the SiNWs were grown. A pitch coated powder formed as described above was heat treated under nitrogen atmosphere at a temperature of 800° C. to prepare a negative active material.

### Evaluation Example 1

Evaluation of Battery Properties

Lifespan properties were evaluated as follows with respect to the batteries manufactured in Example 1, and Comparative Examples 1 and 2:

The charging and discharging experiment was performed at room temperature of 25° C. As an initial formation step, charging at 0.2 C and discharging at 0.2 C was performed once, and then charging at 0.5 C and discharging at 0.5 C was performed once. Lifespan was evaluated by repeating charging at 1.0 C and discharging at 1.0 C for more than 200 times. Lifespan properties were calculated by using capacity retention ratio denoted by Equation 1 below.

Capacity retention rate[%]=[discharge capacity in each cycle/discharge capacity in a first cycle]×100 Equation 1

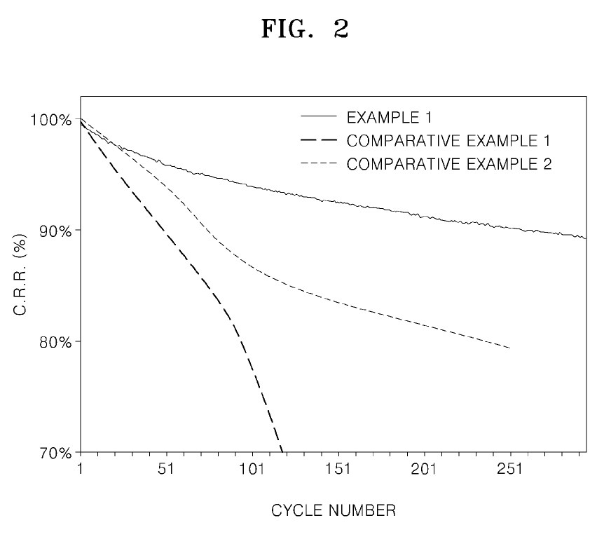

Measurement results of capacity retention rates of the lithium batteries manufactured in Example 1, and Comparative Examples 1 and 2 are shown in FIG. 2 below.

As shown in FIG. 2, the SiNW negative active material prepared by using a non-carbonaceous conductive core showed substantial increase in lifespan properties, compared to the SiNW negative active material prepared by using a graphite substrate. As observed in Comparative Example 2, lifespan properties may be substantially increased by using a pitch coating, compared to the Comparative Example 1, but insufficient lifespan properties have been obtained. The insufficient lifespan properties were supplemented by using a metal core, as in Example 1.

As described above, in some embodiments, the negative active material may supplement irreversible capacity loss caused by volumetric expansion/contraction during charging and discharging of the lithium battery, and may increase cycle lifespan properties of the lithium battery.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A negative active material comprising a primary particle, wherein the primary particle comprises:
a non-carbonaceous conductive core; and
a silicon-based nanowire disposed on the non-carbonaceous conductive core.

2. The negative active material of claim 1, wherein the non-carbonaceous conductive core comprises at least one selected from copper (Cu), nickel (Ni), cobalt (Co), iron (Fe), manganese (Mn), molybdenum (Mo), titanium (Ti), silicon (Si), and an alloy thereof.

3. The negative active material of claim 1, wherein the non-carbonaceous conductive core has a spherical powder form.

4. The negative active material of claim 1, wherein an average diameter of the non-carbonaceous conductive core is in the range of about 1 μm to about 30 μm.

5. The negative active material of claim 1, wherein;
the silicon-based nanowire comprises at least one selected from Si, SiOx (0<x<2), Si—Z alloys (where Z is alkali metal, alkaline earth metal, a Group 11 element, a Group 12 element, a Group 13 element, a Group 14 element, a Group 15 element, a Group 16 element, a transition metal, a rare earth element, or a combination thereof, and is not Si), or a combination thereof.

6. The negative active material of claim 1, wherein the silicon-based nanowire is a silicon nanowire.

7. The negative active material of claim 1, wherein the silicon-based nanowire has a diameter in the range of about 10 nm to about 500 nm, and a length in the range of about 0.1 μm to about 100 μm.

8. The negative active material of claim 1, wherein the silicon-based nanowire is directly grown on the non-carbonaceous conductive core.

9. The negative active material of claim 8, wherein the silicon-based nanowire is grown in the presence of at least one metal catalyst selected from the group consisting of platinum (Pt), iron (Fe), nickel (Ni), cobalt (Co), gold (Au), silver (Ag), copper (Cu), zinc (Zn), cadmium (Cd), and any combinations thereof.

10. The negative active material of claim 1, wherein the amount of the non-carbonaceous conductive core is about 60 wt % to about 99 wt % and the amount of the silicon-based nanowire is about 1 wt % to about 40 wt %, based on the amount of the primary particle.

11. The negative active material of claim 1, wherein the primary particle further comprises an amorphous carbonaceous coating layer, and wherein the amorphous carbonaceous coating layer is coated on at least a portion of the primary particle, such that at least a portion of the silicon-based nanowire is not exposed.

12. The negative active material of claim 11, wherein at least about 50 volume % of the silicon-based nanowire is buried in the amorphous carbonaceous coating layer.

13. The negative active material of claim 11, wherein the thickness of the amorphous carbonaceous coating layer is in the range of about 0.1 μm to about 10 μm.

14. The negative active material of claim 11, wherein the amorphous carbonaceous coating layer comprises amorphous carbon selected from the group consisting of soft carbon, hard carbon, mesophase pitch carbide, calcined coke, and a combination thereof.

15. The negative active material of claim 11, wherein the amount of the amorphous carbonaceous coating layer is in the range of about 0.1 wt % to about 30 wt %, based on the amount of the primary particle.

16. The negative active material of claim 1, wherein the negative active material further comprises at least one carbon-based particle of natural graphite, synthetic graphite, expandable graphite, graphene, carbon black, fullerene soot, carbon nanotubes, carbon fibers, and a combination thereof.

17. The negative active material of claim 16, wherein the carbon-based particle has a spherical form, a flat form, a fiber form, a tube form, or a powder form.

18. A lithium battery comprising:
a negative electrode comprising the negative active material according to claim 1;
a positive electrode comprising a positive active material, which is disposed opposite to the negative electrode; and
an electrolyte disposed between the negative electrode and the positive electrode.

19. The lithium battery of claim 18, wherein the negative electrode further comprises at least one binder selected from the group consisting of polyvinylidene fluoride, polyvinylidene chloride, polybenzimidazole, polyimide, polyvinyl acetate, polyacrylonitrile, polyvinyl alcohol, carboxymethylcellulose (CMC), starch, hydroxypropyl cellulose, regenerated cellulose, polyvinylpyrrolidone, polyethylene, polypropylene, polystyrene, polymethylmethacrylate, polyaniline, acrylonitrile butadiene styrene, a phenol resin, an epoxy resin, polyethylene terephthalate, polytetrafluoroethylene, polyphenylene sulfide, polyamide imide, polyether imide, polyethylene sulfone, polyamide, polyacetal, polyphenylene oxide, polybutylene terephthalate, ethylene-propylene-diene terpolymer (EPDM), sulfonated ethylene-propylene-diene terpolymer, styrene butadiene rubber, fluoride rubber, and a combination thereof.

20. The lithium battery of claim 18, wherein the negative electrode comprises at least one conductive agent selected from the group consisting of carbon black, acetylene black, Ketjen black, carbon fiber, copper, nickel, aluminum, silver, conductive polymer, and a combination thereof.
